(19) United States
(12) Patent Application Publication
(10) Pub. No.: US 2026/0045000 A1
(43) Pub. Date: Feb. 12, 2026

(54) METHOD FOR GENERATING IMAGE, APPARATUS, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Zhenyu Zhang, Beijing (CN); Yi Song, Beijing (CN); Shuohuan Wang, Beijing (CN); Yu Sun, Beijing (CN); Hua Wu, Beijing (CN)

(73) Assignee: BEIJING BAIDU NETCOM SCIENCE TECHNOLOGY CO., LTD., Beijing (CN)

(21) Appl. No.: 19/360,745

(22) Filed: Oct. 16, 2025

(30) Foreign Application Priority Data
Jun. 16, 2025 (CN) 202510806427.9

(51) Int. Cl. G06T 11/00; G06F 40/284; G06T 3/4007; G06T 7/00

(52) U.S. Cl. CPC G06T 11/00; G06F 40/284; G06T 3/4007; G06T 7/0002; G06T 2207/30168

(57) ABSTRACT

An image generation method, an apparatus, an electronic device and a storage medium are provided. The method includes: discretizing a target text to obtain a plurality of text tokens; obtaining a resolution sequence based on an initial resolution and a target resolution, wherein the resolution sequence comprises a plurality of resolutions, and a difference between two adjacent resolutions of the plurality of resolutions is a preset increment; generating image tokens corresponding respectively to the plurality of resolutions based on the plurality of text tokens and the resolution sequence; and fusing all the image tokens to obtain a target image corresponding to the target text.

### CROSS-REFERENCE TO RELATED APPLICATIONS

The present disclosure is based upon and claims priority to Chinese Patent Application No. 2025108064279, filed on Jun. 16, 2025, the entire content of which is incorporated herein by reference for all purposes.

### FIELD

The present disclosure relates to the field of computer technology, particularly to the fields of artificial intelligence technologies such as computer vision, deep learning, and large models, and specifically relates to an image generation method, apparatus, electronic device, and storage medium, which can be applied to scenarios such as artificial intelligence-based content generation.

### BACKGROUND

In recent years, image generation methods based on the autoregressive paradigm have achieved great success. Given a target image category or a piece of text description, a diffusion model or an autoregressive model can generate an image that meets the requirements, which can lower the threshold for creation and accelerate content generation.

As people's requirements for image resolution and details increase, improving the quality of generated images has become an important issue in the development of the image generation field.

### SUMMARY

The present disclosure aims to solve at least one of the technical problems in the related art to some extent.

To this end, an objective of the present disclosure is to provide an image generation method, apparatus, electronic device, and storage medium. By gradually generating multiple image tokens from low resolution to high resolution and adding the image tokens to obtain the target generated image, the image contains richer information, and during the generation process, the image tokens are continuously evaluated, and poorly performing parts are corrected in a timely manner, thereby achieving quality improvement for specific generated images.

According to a first aspect of the present disclosure, an image generation method is provided, including:
discretizing a target text to obtain a plurality of text tokens;
obtaining a resolution sequence based on an initial resolution and a target resolution, where the resolution sequence comprises a plurality of resolutions, and a difference between two adjacent resolutions is a preset increment;
generating image tokens corresponding respectively to the plurality of resolutions based on the plurality of text tokens and the resolution sequence; and
fusing all the image tokens to obtain a target image corresponding to the target text.

According to a second aspect of the present disclosure, an apparatus for generating image is provided, including:
a processing module, configured to discretize a target text to obtain a plurality of text tokens;
a determination module, configured to obtain a resolution sequence based on an initial resolution and a target resolution, where the resolution sequence comprises a plurality of resolutions, and a difference between two adjacent resolutions is a preset increment;
a first generation module, configured to generate image tokens corresponding respectively to the plurality of resolutions based on the plurality of text tokens and the resolution sequence; and
a second generation module, configured to fuse all the image tokens to obtain a target image corresponding to the target text.

According to a third aspect of the present disclosure, an electronic device is provided, including:
at least one processor; and
a memory communicatively coupled to the at least one processor; where

the memory stores instructions executable by the at least one processor, and the instructions, when executed by the at least one processor, cause the at least one processor to perform the image generation method according to the first aspect.

According to a fourth aspect of the present disclosure, a non-transitory computer-readable storage medium storing computer instructions is provided, where the computer instructions are configured to cause a computer to perform the image generation method according to the first aspect.

According to a fifth aspect of the present disclosure, a computer program product is provided, including computer instructions, where the computer instructions, when executed by a processor, implement the steps of the image generation method according to the first aspect.

The image generation method, apparatus, electronic device, and storage medium provided by the present disclosure have the following beneficial effects:

First, the target text is discretized to obtain a plurality of text tokens; a resolution sequence is obtained based on an initial resolution and a target resolution; then, image tokens corresponding to each resolution are generated based on the plurality of text tokens and the resolution sequence; and finally, all the image tokens are fused to obtain a target image corresponding to the target text. By generating image tokens of multiple resolutions and fusing image tokens of different resolutions to obtain the target image, the generated image can capture different features and details, the image information is richer, and the quality of the image generation result is improved.

It should be understood that the content described in this section is not intended to identify key or important features of the embodiments of the present disclosure, nor is it intended to limit the scope of the present disclosure. Other features of the present disclosure will become apparent from the following description.

### BRIEF DESCRIPTION OF THE DRAWINGS

The above and/or additional aspects and advantages of the present disclosure will become apparent and readily understood from the following description of embodiments in conjunction with the accompanying drawings. The drawings are used to provide a better understanding of the solution and do not constitute a limitation of the present disclosure.

FIG. 1 is a schematic flowchart of an image generation method according to an embodiment of the present disclosure;

FIG. 2 is a schematic flowchart of an image generation method according to another embodiment of the present disclosure;

FIG. 3 is a schematic diagram of an image generation process according to an embodiment of the present disclosure;

FIG. 4 is a schematic structural diagram of an apparatus for generating image according to an embodiment of the present disclosure; and

FIG. 5 is a block diagram showing an exemplary electronic device suitable for implementing embodiments of the present disclosure.

### DETAILED DESCRIPTION

Exemplary embodiments of the present disclosure are described below with reference to the accompanying drawings, which include various details of the embodiments of the present disclosure to facilitate understanding and should be considered as merely exemplary. Therefore, those of ordinary skill in the art should recognize that various changes and modifications can be made to the embodiments described herein without departing from the scope and spirit of the present disclosure. Likewise, for clarity and conciseness, descriptions of well-known functions and structures are omitted in the following description.

The embodiments of the present disclosure relate to the fields of artificial intelligence technologies such as computer vision, deep learning, and large models.

Artificial Intelligence (AI) is a new technical science that studies and develops theories, methods, technologies, and application systems for simulating, extending, and expanding human intelligence.

Deep learning involves learning the internal laws and representation levels of sample data. The information obtained during these learning processes is very helpful for interpreting data such as text, images, and sound. The ultimate goal of deep learning is to enable machines to have analytical learning capabilities like humans and to recognize data such as text, images, and sound.

Computer vision refers to machine vision that uses cameras and computers instead of human eyes to identify, track, and measure targets, and further performs graphic processing to make the computer-processed images more suitable for human eye observation or transmission to instruments for detection.

Artificial intelligence large models (referred to as “large models”) are a type of artificial intelligence model constructed by artificial neural networks with a large number of parameters. They are usually pre-trained on massive data through self-supervised learning or semi-supervised learning, and then further optimized in terms of performance and capabilities through methods such as instruction fine-tuning and human alignment. Large models have characteristics such as a large number of parameters, large training data, and large computational resources, and possess capabilities such as solving general tasks, following human instructions, and performing complex reasoning.

In the technical solutions of the present disclosure, the collection, storage, use, processing, transmission, provision, and disclosure of user personal information involved are all in compliance with relevant laws and regulations and do not violate public order and good customs.

The image generation method, apparatus, electronic device, and storage medium of the embodiments of the present disclosure are described below with reference to the accompanying drawings.

It should be noted that the execution subject of the image generation method in this embodiment is an apparatus for generating image, which can be implemented by software and/or hardware. The apparatus can be configured in an electronic device, and the electronic device can include, but is not limited to, terminals, servers, etc.

FIG. 1 is a schematic flowchart of an image generation method according to an embodiment of the present disclosure.

As shown in FIG. 1, the image generation method includes:

S101: discretizing a target text to obtain a plurality of text tokens.

The target text is a description of the content in the target generated image, for example, “blue sky”. A text token is the smallest semantic unit in the target text, such as a word, subword, or character.

In the embodiment of the present disclosure, the target text can be obtained in various ways, for example, it can be obtained through user input, or a piece of text can be selected from a document or webpage as the target text, etc., which is not limited in the present disclosure.

In the embodiment of the present disclosure, predefined rules or neural networks can be used to segment the target text, discretizing it into a plurality of text tokens, so that the image generation model can process it more efficiently when generating images based on the target text.

S102: obtaining a resolution sequence based on an initial resolution and a target resolution.

The initial resolution is the lowest resolution that the model can generate images. For different types of models actually used for image generation, the initial resolution may be different due to model output limitations, for example, it can be 8×8.

The target resolution is the highest resolution of the generated image. The target resolution can be set according to the actual resolution requirements of the generated image, available resources, and model capabilities, etc.

The resolution sequence includes a plurality of resolutions, and a difference between two adjacent resolutions is a preset increment.

In the embodiment of the present disclosure, the image generation model does not directly generate an image but adopts a progressive residual quantization method to transform the generation process of an image into the generation process of images of different resolutions. Multiple image tokens are gradually generated from low resolution to high resolution, and the image tokens are fused to obtain the target image. The speed of increasing from low resolution to high resolution can be customized according to computational resource constraints, image generation rate requirements, etc. Therefore, a preset increment can be set. Starting from the initial resolution, a resolution for which an image token needs to be generated is determined each time the preset increment is added until the target resolution is reached, thereby obtaining the resolution sequence. From this resolution sequence, the model can determine the resolution of the image that needs to be generated at each step.

S103: generating image tokens corresponding respectively to the plurality of resolutions based on the plurality of text tokens and the resolution sequence.

In the embodiment of the present disclosure, the image generation model can generate image tokens corresponding to each resolution based on a unified generation framework of Visual Auto Regression. In this framework, the backbone network follows the structure of Transformer commonly used in large language models.

In the embodiment of the present disclosure, the plurality of text tokens can be input into the image generation model. The image encoder in the image generation model can use a progressive residual quantization method according to the resolution sequence to transform the image generation process into the generation process of images of different resolutions, generating them step by step from low resolution to high resolution, and obtain image tokens corresponding to each resolution in the resolution sequence.

It should be noted that each image token corresponds to a local region or feature of the image (such as a color block, edge, texture, etc.). Therefore, after the image generation model maps the plurality of text tokens into high-dimensional semantic vectors through an encoder (such as Transformer), it should generate a plurality of image tokens of the same resolution according to the semantic vectors to respectively correspond to a part of the target image.

In the embodiment of the present disclosure, in order to improve the quality of the generated image, after generating the image token corresponding to each resolution, the image token can be evaluated for quality and corrected, and then the corrected image token can be used to determine the image token of a higher resolution. This can ensure that the image token corresponding to each resolution has a better effect, and thus the quality of the final generated image after fusing the image tokens will be higher.

S104: fusing all the image tokens to obtain a target image corresponding to the target text.

In the embodiment of the present disclosure, all image tokens corresponding to all resolutions can be normalized to have similar pixel value ranges or distributions, avoiding fusion deviations caused by scale differences. Then, all image tokens are accumulated to obtain the target image corresponding to the target text.

In this embodiment, the target text is first discretized to obtain a plurality of text tokens; a resolution sequence is obtained based on an initial resolution and a target resolution; then, image tokens corresponding to each resolution are generated based on the plurality of text tokens and the resolution sequence; and finally, all the image tokens are fused to obtain a target image corresponding to the target text. By generating image tokens of multiple resolutions and fusing image tokens of different resolutions to obtain the target image, the generated image can capture different features and details, the image information is richer, and the quality of the image generation result is improved.

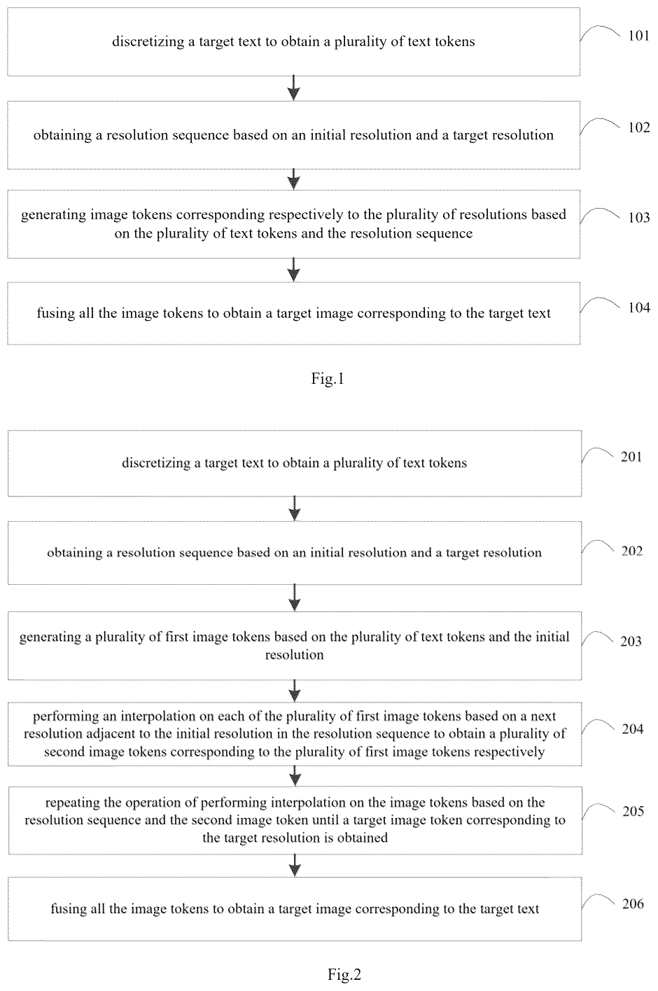

FIG. 2 is a schematic flowchart of an image generation method according to another embodiment of the present disclosure.

As shown in FIG. 2, the image generation method includes:

S201: discretizing a target text to obtain a plurality of text tokens.

S202: obtaining a resolution sequence based on an initial resolution and a target resolution.

The description of S201 and S202 can be referred to the above embodiment and will not be repeated here.

S203: generating a plurality of first image tokens based on the plurality of text tokens and the initial resolution.

In the embodiment of the present disclosure, the plurality of text tokens can be input into an image generation model based on a unified generation framework of Visual Auto Regression. The image encoder in the image generation model can generate a plurality of first image tokens with the initial resolution based on the plurality of text tokens. Each first image token can correspond to one or more text tokens.

In the present disclosure, in order to improve the quality of the generated image, after generating the image token corresponding to each resolution, the image token can be evaluated for quality and corrected, and then the corrected image token can be used to determine the image token of a higher resolution. This can ensure that the image token corresponding to each resolution has a better effect, and thus the quality of the final generated image after fusing the image tokens will be higher.

Optionally, a quality score for each first image token may be determined first. Then, in response to any first image token having a quality score lower than a score threshold, a new first image token is generated based on the first image token, the initial resolution, and a text token corresponding to the first image token.

The score threshold can be set according to actual needs, which is not limited in the present disclosure. The higher the quality requirements for the generated image, the smaller the score threshold can be set, while also considering whether computational resources are sufficient. The score threshold cannot be too small.

In the embodiment of the present disclosure, external tools can be used to evaluate the first image tokens to obtain a quality score for each first image token, and then each quality score is compared with the score threshold. All first image tokens with quality scores lower than the score threshold are determined to have poor quality evaluation results. Then, the generation can be performed again based on the generation result of the current resolution to improve the generation quality, that is, the first image token with poor quality and its corresponding text token are re-input into the model to obtain a new first image token with the initial resolution output by the model.

In the embodiment of the present disclosure, by evaluating the quality of the image token after generating the image token corresponding to each resolution and correcting the image token with poor quality, it can be ensured that the image token corresponding to each resolution has a better effect, and thus the quality of the final generated image after fusing the image tokens will be higher.

S204: performing an interpolation on each of the plurality of first image tokens based on a next resolution adjacent to the initial resolution in the resolution sequence to obtain a plurality of second image tokens corresponding to the plurality of first image tokens respectively.

In the embodiment of the present disclosure, after obtaining the first image tokens, the next resolution adjacent to the initial resolution in the resolution sequence can be determined as the resolution of the next image token to be generated. Any interpolation method, such as linear interpolation, can be selected as needed to interpolate a first image token into an image token with a resolution that is the next resolution adjacent to the initial resolution, thereby obtaining a second image token.

In the present disclosure, each first image token can be interpolated to obtain a corresponding second image token. Multiple interpolation methods can also be applied to the first image tokens to obtain multiple second image tokens, to further improve the richness of graphic information after image token fusion.

In the present disclosure, in order to improve the quality of the generated image, after generating the image token corresponding to each resolution, the image token can be evaluated for quality and corrected, and then the corrected image token can be used to determine the image token of a higher resolution. This can ensure that the image token corresponding to each resolution has a better effect, and thus the quality of the final generated image after fusing the image tokens will be higher.

Optionally, a quality score of the second image token may be determined. Then, in response to the quality score being lower than a score threshold, a new second image token is generated based on the first image token and the second image token.

It should be noted that the process of determining the quality score of the second image token may be similar to the process of determining the quality score of the first image token described above, and the setting of the score threshold may be the same or different.

In the embodiment of the present disclosure, the second image token with a quality score lower than the score threshold can be added to its corresponding first image token, and a new second image token can be regenerated through the Transformer network in the image generation model. This second image token is generated based on the first image token and has the same resolution as the original second image token but different content.

In the embodiment of the present disclosure, by evaluating the quality of the image token after generating the image token corresponding to each resolution and correcting the image token with poor quality, it can be ensured that the image token corresponding to each resolution has a better effect, and thus the quality of the final generated image after fusing the image tokens will be higher.

It should be noted that, in the embodiment of the present disclosure, in addition to using external tools to score the quality of image tokens, the quality of the image token generated each time can also be evaluated through pixel value changes during the generation process, automatically identifying regions that may need optimization, and modifying the region to be optimized once at the current resolution.

Optionally, first, a pixel value difference between the second image token and its corresponding first image token is calculated.

In the embodiment of the present disclosure, first, the second image token and its corresponding first image token are completely aligned in space by cropping or registration. Then, all pixel positions are traversed, and the difference between the pixel value of the second image token and the pixel value of the first image token at each pixel position is calculated, thereby obtaining the pixel value difference between the second image token and its corresponding first image token. The pixel value difference can be recorded in matrix form.

Then, a target region to be corrected in the second image token is determined based on the pixel value difference and a difference threshold.

The difference threshold is a critical value used to measure the small change in pixel value during the change from the first image token to the second image token. It can be set as needed, and when evaluating images of different resolutions, the difference threshold can be different.

In the embodiment of the present disclosure, after obtaining the pixel value difference between the second image token and its corresponding first image token, the relationship between the pixel value difference at each pixel position and the difference threshold can be traversed. The pixel positions where the pixel value difference is less than the difference threshold are determined as the target region to be corrected in the second image token, thereby ensuring that at each step of generating a higher-resolution image token, obvious content refinement is performed compared to the image token of the previous resolution.

Then, the second image token can be corrected based on the first image token and the target region to obtain a new second image token.

In the embodiment of the present disclosure, after determining the target region to be corrected in the second image token, the target region of the second image token can be modified based on the first image token to obtain a new second image token. This can achieve the requirement of modifying multiple target regions in the image, more accurately improve the image quality, ensure that the image token corresponding to each resolution has a better effect, and thus the quality of the final generated image after fusing the image tokens will be higher.

It should be noted that, in the embodiment of the present disclosure, different difference thresholds can be set when evaluating images of different resolutions.

Optionally, in response to a resolution of the second image token being less than a resolution threshold, a region in the second image token where the pixel value difference is less than a first difference threshold is determined as the target region.

Alternatively, in response to a resolution of the second image token being greater than or equal to a resolution threshold, a region in the second image token where the pixel value difference is less than a second difference threshold is determined as the target region.

The second difference threshold is less than the first difference threshold.

In the embodiment of the present disclosure, since in the early stage when the resolution is relatively low, more attention is paid to the outline of the image, and it is hoped that there will be a relatively large change in pixel values between two generation results, a relatively large difference threshold can be set to measure the quality of the generated image token. In the later stage when the resolution is relatively high, more attention is paid to image details, and a relatively small change threshold can be set to measure the quality of the generated image token, ensuring that when images of different resolutions are fused later, the problem of inability to fuse at the same position is avoided. Thus, by setting different evaluation thresholds when evaluating the quality of images of different resolutions, the reliability of image correction is improved.

S205: repeating the operation of performing interpolation on the image tokens based on the resolution sequence and the second image token until a target image token corresponding to the target resolution is obtained.

For example, the S205 may include: performing the interpolation on each of the plurality of second image tokens based on a next resolution adjacent to a resolution corresponding to a respective second image token in the resolution sequence, to obtain a target image token corresponding to the target resolution

In the embodiment of the present disclosure, after obtaining the second image token, the interpolation process can be performed again on the second image token so that the resolution of the new image token after interpolation is the next resolution in the resolution sequence. This is repeated multiple times until the target image token corresponding to the target resolution is obtained. And after each time a new resolution image token is obtained, it can be evaluated for quality and corrected. The methods for quality evaluation and correction are the same as those for the second image token.

In the embodiment of the present disclosure, if the quality of the image token generated at any time is good, the image token can be directly interpolated to obtain the next image token with a higher resolution. Conversely, if the quality of the image token generated at any time is poor, the image token needs to be corrected first, and the corrected image token is used for interpolation to obtain the next image token with a higher resolution.

S206: fusing all the image tokens to obtain a target image corresponding to the target text.

The description of S206 can be referred to the above embodiment and will not be repeated here.

In this embodiment, by gradually interpolating low-resolution image tokens to obtain high-resolution image tokens, high-frequency details can be restored, blurring can be reduced, and by optimizing image content in stages, the structural rationality of each step can be ensured, further improving the quality of the generated image.

The image generation method under the visual autoregressive paradigm proposed by the present disclosure improves image quality without relying on additional image editing models, can directly integrate quality improvement capabilities into the image generation framework, and requires a shorter generation sequence length, thus is faster and has lower computational costs.

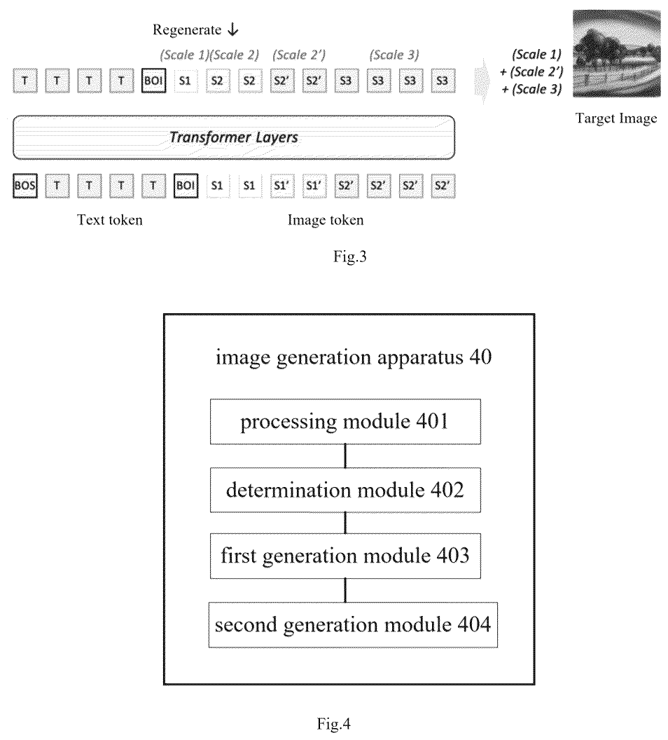

The image generation process is described below with reference to FIG. 3. FIG. 3 is a schematic diagram of an image generation process according to an embodiment of the present disclosure.

In FIG. 3, BOS (Begin Of Sentence) is the start symbol of text tokens (Text Tokens), and text tokens are represented by the letter T in FIG. 3. BOI (Begin Of Image) is the start symbol of image tokens (Image Tokens). S1 represents the image token of the first resolution (Scale), S2 represents the image token of the second resolution (Scale), and so on.

First, a plurality of text tokens T are input into the Transformer network to generate the image token S1 of the first resolution. Then, by performing different interpolation processes on S1, a plurality of image tokens S2 of the second resolution can be obtained. The model evaluates that the quality of S2 is poor and needs to correct and regenerate the current Scale result (Regeneration). S1 can be added to S2 (represented as S1′ in FIG. 3), and a corrected result is obtained through the Transformer, denoted as S2′. Subsequent results can then be generated based on Scale2′ to generate S3 until the target resolution is reached. After the results of all resolutions are generated, all results are accumulated and sent to the image decoder to obtain the final image. In the case where the image token corresponding to the target resolution is S3 and the quality of S3 is good, all of S1, S2′, and S3 can be added to obtain the final generated image.

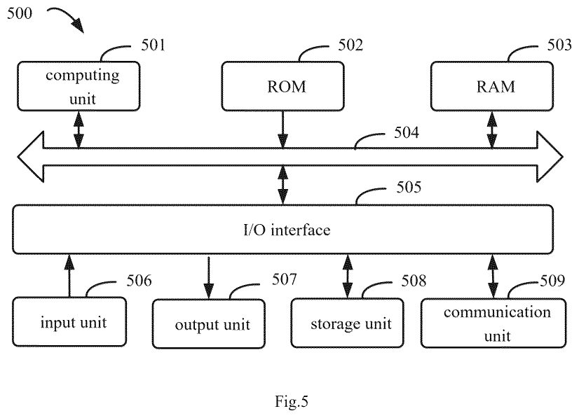

FIG. 4 is a schematic structural diagram of an apparatus for generating image according to an embodiment of the present disclosure.

As shown in FIG. 4, the image generation apparatus 40 includes:
a processing module 401, configured to discretize a target text to obtain a plurality of text tokens;
a determination module 402, configured to obtain a resolution sequence based on an initial resolution and a target resolution, where the resolution sequence comprises a plurality of resolutions, and a difference between two adjacent resolutions is a preset increment;
a first generation module 403, configured to generate image tokens corresponding respectively to the plurality of resolutions based on the plurality of text tokens and the resolution sequence; and
a second generation module 404, configured to fuse all the image tokens to obtain a target image corresponding to the target text.

In some embodiments, the first generation module 403 is further configured to:
generate a plurality of first image tokens based on the plurality of text tokens and the initial resolution;
perform an interpolation on each of the plurality of first image tokens based on a next resolution adjacent to the initial resolution in the resolution sequence to obtain a second image token; and
repeat the operation of performing interpolation on the image tokens based on the resolution sequence and the second image token until a target image token corresponding to the target resolution is obtained.

In some embodiments, the first generation module 403 is further configured to:
determine quality scores for the plurality of first image tokens respectively; and
in response to any of the plurality of first image tokens having a quality score lower than a score threshold, generate a new first image token based on the first image token having the quality score lower than the score threshold, the initial resolution and a text token corresponding to the first image token having the quality score lower than the score threshold.

In some embodiments, the first generation module 403 is further configured to:
determine quality scores for the plurality of second image tokens respectively; and
in response to the quality scores being lower than a score threshold, generate new second image tokens based on the first image tokens and the second image tokens.

In some embodiments, the first generation module 403 is further configured to:
for each of the plurality of second image tokens, calculate pixel value differences between the second image token and a first image token corresponding to the second image token;
determine a target region to be corrected in the second image token based on the pixel value difference and a difference threshold; and
correct the second image token based on the first image token and the target region to obtain a new second image token.

In some embodiments, the first generation module 403 is further configured to:
in response to a resolution of the second image token being less than a resolution threshold, determine, from the second image token, a region where the pixel value difference is less than a first difference threshold as the target region; or
in response to a resolution of the second image token being greater than or equal to a resolution threshold, determine, from the second image token, a region where the pixel value difference is less than a second difference threshold as the target region, where the second difference threshold is less than the first difference threshold.

It should be noted that the foregoing explanation of the image generation method also applies to the image generation apparatus of this embodiment and will not be repeated here.

In this embodiment, the target text is first discretized to obtain a plurality of text tokens; a resolution sequence is obtained based on an initial resolution and a target resolution; then, image tokens corresponding to each resolution are generated based on the plurality of text tokens and the resolution sequence; and finally, all the image tokens are fused to obtain a target image corresponding to the target text. By generating image tokens of multiple resolutions and fusing image tokens of different resolutions to obtain the target image, the generated image can capture different features and details, the image information is richer, and the quality of the image generation result is improved.

According to the embodiments of the present disclosure, the present disclosure also provides an electronic device, a readable storage medium, and a computer program product.

FIG. 5 shows a schematic block diagram of an exemplary electronic device 500 suitable for implementing embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile devices, such as personal digital assistants, cellular phones, smartphones, wearable devices, and other similar computing devices. The components shown herein, their connections and relationships, and their functions are meant to be exemplary only, and are not intended to limit the implementation of the present disclosure described and/or claimed herein.

As shown in FIG. 5, the device 500 includes a computing unit 501, which may perform various appropriate actions and processing according to a computer program stored in a read-only memory (ROM) 502 or a computer program loaded from a storage unit 508 into a random access memory (RAM) 503. In the RAM 503, various programs and data required for the operation of the device 500 may also be stored. The computing unit 501, the ROM 502, and the RAM 503 are connected to each other via a bus 504. An input/output (I/O) interface 505 is also connected to the bus 504.

Various components in the device 500 are connected to the I/O interface 505, including: an input unit 506, such as a keyboard, a mouse, etc.; an output unit 507, such as various types of displays, speakers, etc.; a storage unit 508, such as a magnetic disk, an optical disk, etc.; and a communication unit 509, such as a network card, a modem, a wireless communication transceiver, etc. The communication unit 509 allows the device 500 to exchange information/data with other devices through computer networks such as the Internet and/or various telecommunications networks.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, digital signal processors (DSP), and any appropriate processor, controller, microcontroller, etc. The computing unit 501 performs the various methods and processes described above, such as the image generation method. For example, in some embodiments, the image generation method may be implemented as a computer software program that is tangibly contained in a machine-readable medium, such as the storage unit 508. In some embodiments, part or all of the computer program may be loaded and/or installed onto the device 500 via the ROM 502 and/or the communication unit 509. When the computer program is loaded into the RAM 503 and executed by the computing unit 501, one or more steps of the image generation method described above may be performed. Alternatively, in other embodiments, the computing unit 501 may be configured to perform the image generation method by any other appropriate means (for example, by means of firmware).

The various implementations of the systems and technologies described herein may be implemented in digital electronic circuit systems, integrated circuit systems, field-programmable gate arrays (FPGAs), application-specific integrated circuits (ASICs), application-specific standard products (ASSPs), system-on-a-chip systems (SOCs), complex programmable logic devices (CPLDs), computer hardware, firmware, software, and/or combinations thereof. These various implementations may include: implementation in one or more computer programs that may be executed and/or interpreted on a programmable system including at least one programmable processor. The programmable processor may be a special-purpose or general-purpose programmable processor, may receive data and instructions from a storage system, at least one input device, and at least one output device, and may transmit data and instructions to the storage system, the at least one input device, and the at least one output device.

Program code for implementing the methods of the present disclosure may be written in any combination of one or more programming languages. These program codes may be provided to a processor or controller of a general-purpose computer, special-purpose computer, or other programmable data processing apparatus such that the program codes, when executed by the processor or controller, cause the functions/operations specified in the flowcharts and/or block diagrams to be implemented. The program code may be executed entirely on the machine, partly on the machine, partly on the machine and partly on a remote machine, or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of machine-readable storage media would include electrical connections based on one or more wires, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide for interaction with a user, the systems and technologies described herein may be implemented on a computer having: a display device (e.g., a CRT (cathode ray tube) or LCD (liquid crystal display) monitor) for displaying information to the user; and a keyboard and a pointing device (e.g., a mouse or a trackball) through which the user may provide input to the computer. Other kinds of devices may also be used to provide for interaction with the user; for example, feedback provided to the user may be any form of sensory feedback (e.g., visual feedback, auditory feedback, or tactile feedback); and input from the user may be received in any form, including acoustic input, voice input, or tactile input.

The systems and technologies described herein may be implemented in a computing system that includes back-end components (e.g., as a data server), or that includes middleware components (e.g., an application server), or that includes front-end components (e.g., a user computer having a graphical user interface or a web browser through which a user may interact with implementations of the systems and technologies described herein), or any combination of such back-end components, middleware components, or front-end components. The components of the system may be interconnected by any form or medium of digital data communication (e.g., a communication network). Examples of communication networks include: local area networks (LAN), wide area networks (WAN), the Internet, and blockchain networks.

The computer system may include clients and servers. A client and server are generally remote from each other and typically interact through a communication network. The relationship of client and server arises by virtue of computer programs running on the respective computers and having a client-server relationship to each other. The server may be a cloud server, also known as a cloud computing server or cloud host, which is a host product in the cloud computing service system to solve the defects of difficult management and weak business scalability in traditional physical hosts and VPS services (“Virtual Private Server”, or “VPS” for short). The server may also be a server of a distributed system or a server combined with blockchain.

It should be understood that the various forms of processes shown above may be used, with steps reordered, added, or deleted. For example, the steps described in the present disclosure may be performed in parallel, sequentially, or in different orders, as long as the desired results of the technical solutions disclosed in the present disclosure are achieved. This is not limited herein.

Furthermore, the terms “first” and “second” are used for descriptive purposes only and are not to be construed as indicating or implying relative importance or implicitly specifying the quantity of the indicated technical features. Thus, features defined with “first” and “second” may explicitly or implicitly include at least one such feature. In the description of the present disclosure, “a plurality” means at least two, such as two, three, etc., unless otherwise specifically defined. In the description of the present disclosure, the terms “if” and “in case” may be interpreted as “when” or “upon” or “in response to determining” or “in response to detecting” or “under the circumstance of”.

The above specific embodiments do not constitute a limitation on the protection scope of the present disclosure. Those skilled in the art should understand that various modifications, combinations, sub-combinations, and substitutions can be made according to design requirements and other factors. Any modifications, equivalent replacements, and improvements made within the spirit and principles of the present disclosure shall be included within the protection scope of the present disclosure.

What is claimed is:

1. A method for generating image, comprising:
discretizing a target text to obtain a plurality of text tokens;
obtaining a resolution sequence based on an initial resolution and a target resolution, wherein the resolution sequence comprises a plurality of resolutions, and a difference between two adjacent resolutions of the plurality of resolutions is a preset increment;
generating image tokens corresponding respectively to the plurality of resolutions based on the plurality of text tokens and the resolution sequence; and
fusing all the image tokens to obtain a target image corresponding to the target text.

2. The method according to claim 1, wherein generating the image tokens corresponding respectively to the plurality of resolutions based on the plurality of text tokens and the resolution sequence comprises:
generating a plurality of first image tokens based on the plurality of text tokens and the initial resolution;
performing an interpolation on each of the plurality of first image tokens based on a next resolution adjacent to the initial resolution in the resolution sequence to obtain a plurality of second image tokens corresponding to the plurality of first image tokens respectively; and
performing the interpolation on each of the plurality of second image tokens based on a next resolution adjacent to a resolution corresponding to a respective second image token in the resolution sequence, to obtain a target image token corresponding to the target resolution.

3. The method according to claim 2, wherein subsequent to generating the plurality of first image tokens based on the plurality of text tokens and the initial resolution, the method further comprises:
determining quality scores for the plurality of first image tokens respectively; and
in response to any of the plurality of first image tokens having a quality score lower than a score threshold, generating a new first image token based on the first image token having the quality score lower than the score threshold, the initial resolution and a text token corresponding to the first image token having the quality score lower than the score threshold.

4. The method according to claim 2, wherein subsequent to performing the interpolation on each of the plurality of first image tokens to obtain the plurality of second image tokens, the method further comprises:
determining quality scores for the plurality of second image tokens respectively; and
in response to the quality scores being lower than a score threshold, generating new second image tokens based on the first image tokens and the second image tokens.

5. The method according to claim 2, wherein subsequent to performing the interpolation on each of the plurality of first image tokens to obtain the plurality of second image tokens, the method further comprises:
for each of the plurality of second image tokens, calculating pixel value differences between the second image token and a first image token corresponding to the second image token;
determining a target region to be corrected in the second image token based on the pixel value difference and a difference threshold; and
correcting the second image token based on the first image token and the target region to obtain a new second image token.

6. The method according to claim 5, wherein determining the target region to be corrected in the second image token based on the pixel value difference and the difference threshold comprises:
in response to a resolution of the second image token being less than a resolution threshold, determining, from the second image token, a region where the pixel value difference is less than a first difference threshold as the target region; or
in response to a resolution of the second image token being greater than or equal to a resolution threshold, determining, from the second image token, a region where the pixel value difference is less than a second difference threshold as the target region;
wherein the second difference threshold is less than the first difference threshold.

7. An electronic device, comprising:
at least one processor; and
a memory communicatively coupled to the at least one processor;
wherein the memory stores instructions that, when executed by the at least one processor, causes the at least one processor to perform:
discretizing a target text to obtain a plurality of text tokens;
obtaining a resolution sequence based on an initial resolution and a target resolution, wherein the resolution sequence comprises a plurality of resolutions, and a difference between two adjacent resolutions of the plurality of resolutions is a preset increment;
generating image tokens corresponding respectively to the plurality of resolutions based on the plurality of text tokens and the resolution sequence; and
fusing all the image tokens to obtain a target image corresponding to the target text.

8. The electronic device according to claim 7, wherein generating the image tokens corresponding respectively to the plurality of resolutions based on the plurality of text tokens and the resolution sequence comprises:
generating a plurality of first image tokens based on the plurality of text tokens and the initial resolution;
performing an interpolation on each of the plurality of first image tokens based on a next resolution adjacent to the initial resolution in the resolution sequence to obtain a plurality of second image tokens corresponding to the plurality of first image tokens respectively; and
performing the interpolation on each of the plurality of second image tokens based on a next resolution adjacent to a resolution corresponding to a respective second image token in the resolution sequence, to obtain a target image token corresponding to the target resolution.

9. The electronic device according to claim 8, wherein subsequent to generating the plurality of first image tokens based on the plurality of text tokens and the initial resolution, the method further comprises:
determining quality scores for the plurality of first image tokens respectively; and
in response to any of the plurality of first image tokens having a quality score lower than a score threshold, generating a new first image token based on the first image token having the quality score lower than the score threshold, the initial resolution and a text token corresponding to the first image token having the quality score lower than the score threshold.

10. The electronic device according to claim 8, wherein subsequent to performing the interpolation on each of the plurality of first image tokens to obtain the plurality of second image tokens, the method further comprises:
determining quality scores for the plurality of second image tokens respectively; and
in response to the quality scores being lower than a score threshold, generating new second image tokens based on the first image tokens and the second image tokens.

11. The electronic device according to claim 8, wherein subsequent to performing the interpolation on each of the plurality of first image tokens to obtain the plurality of second image tokens, the method further comprises:
for each of the plurality of second image tokens, calculating pixel value differences between the second image token and a first image token corresponding to the second image token;
determining a target region to be corrected in the second image token based on the pixel value difference and a difference threshold; and
correcting the second image token based on the first image token and the target region to obtain a new second image token.

12. The electronic device according to claim 11, wherein determining the target region to be corrected in the second image token based on the pixel value difference and the difference threshold comprises:
in response to a resolution of the second image token being less than a resolution threshold, determining, from the second image token, a region where the pixel value difference is less than a first difference threshold as the target region; or
in response to a resolution of the second image token being greater than or equal to a resolution threshold, determining, from the second image token, a region where the pixel value difference is less than a second difference threshold as the target region;
wherein the second difference threshold is less than the first difference threshold.

13. A non-transitory computer-readable storage medium storing computer instructions, wherein the computer instructions are configured to cause a computer to perform:
discretizing a target text to obtain a plurality of text tokens;
obtaining a resolution sequence based on an initial resolution and a target resolution, wherein the resolution sequence comprises a plurality of resolutions, and a difference between two adjacent resolutions of the plurality of resolutions is a preset increment;
generating image tokens corresponding respectively to the plurality of resolutions based on the plurality of text tokens and the resolution sequence; and
fusing all the image tokens to obtain a target image corresponding to the target text.

14. The non-transitory computer-readable storage medium according to claim 9, wherein generating the image tokens corresponding respectively to the plurality of resolutions based on the plurality of text tokens and the resolution sequence comprises:
generating a plurality of first image tokens based on the plurality of text tokens and the initial resolution;
performing an interpolation on each of the plurality of first image tokens based on a next resolution adjacent to the initial resolution in the resolution sequence to obtain a plurality of second image tokens corresponding to the plurality of first image tokens respectively; and
performing the interpolation on each of the plurality of second image tokens based on a next resolution adjacent to a resolution corresponding to a respective second image token in the resolution sequence, to obtain a target image token corresponding to the target resolution.

15. The non-transitory computer-readable storage medium according to claim 14, wherein subsequent to generating the plurality of first image tokens based on the plurality of text tokens and the initial resolution, the method further comprises:
determining quality scores for the plurality of first image tokens respectively; and
in response to any of the plurality of first image tokens having a quality score lower than a score threshold, generating a new first image token based on the first image token having the quality score lower than the score threshold, the initial resolution and a text token corresponding to the first image token having the quality score lower than the score threshold.

16. The non-transitory computer-readable storage medium according to claim 14, wherein subsequent to performing the interpolation on each of the plurality of first image tokens to obtain the plurality of second image tokens, the method further comprises:
determining quality scores for the plurality of second image tokens respectively; and
in response to the quality scores being lower than a score threshold, generating new second image tokens based on the first image tokens and the second image tokens.

17. The non-transitory computer-readable storage medium according to claim 14, wherein subsequent to performing the interpolation on each of the plurality of first image tokens to obtain the plurality of second image tokens, the method further comprises:
for each of the plurality of second image tokens, calculating pixel value differences between the second image token and a first image token corresponding to the second image token;
determining a target region to be corrected in the second image token based on the pixel value difference and a difference threshold; and
correcting the second image token based on the first image token and the target region to obtain a new second image token.

18. The non-transitory computer-readable storage medium according to claim 17, wherein determining the target region to be corrected in the second image token based on the pixel value difference and the difference threshold comprises:
in response to a resolution of the second image token being less than a resolution threshold, determining, from the second image token, a region where the pixel value difference is less than a first difference threshold as the target region; or
in response to a resolution of the second image token being greater than or equal to a resolution threshold, determining, from the second image token, a region where the pixel value difference is less than a second difference threshold as the target region;
wherein the second difference threshold is less than the first difference threshold.
